(19) United States
(12) Patent Application Publication
(10) Pub. No.: US 2014/0021419 A1
(43) Pub. Date: Jan. 23, 2014

(54) Method for Producing Foam Glass by Recycling a Waste Glass Mixture

(71) Applicants: Ralf Baier, Oranienbaum (DE); Rainer Daniel, Dessau-Rosslau (DE)

(72) Inventors: Ralf Baier, Oranienbaum (DE); Rainer Daniel, Dessau-Rosslau (DE)

(73) Assignee: TDC Trade Development and Construction Ltd., Graefenhainichen (DE)

(21) Appl. No.: 14/110,152

(22) PCT Filed: Apr. 2, 2012
(86) PCT No.: PCT/DE2012/000354

§ 371 Date: Oct. 6, 2013

(30) Foreign Application Priority Data
Apr. 9, 2011 (DE) 10 2011 016 606.8

(51) Int. Cl. C03B 19/08; C09K 21/02; C03C 11/00

(52) U.S. Cl. CPC C03B 19/08; C03C 11/007; C09K 21/02
USPC 252/610; 65/22; 501/39

(57) ABSTRACT

Method for producing foam glass by recycling wasteglass mixture containing screen glass from television sets, computers, monitors and glass from fluorescent tubes, light bulbs and photovoltaic systems. Steps are: separately grinding individual fractions of wasteglass from various sources, forming glass powder; mixing a sintered glass composition including components of various glass powder fractions and an inorganic carbon carrier substance as activator in a dry process without adding water or liquids; and thermally treating the sintered glass composition. This composition is first subjected to a sintering process and later to a foaming process, at temperatures in a range of 855° C. to 890° C. The arising foam glass is subsequently cooled down. The sintered glass composition, which is thermally sintered glass powder and activator, is composed of at least 10 wt % of screen glass, with 85 to 90 wt % originating from screen glass and glass from fluorescent tubes, light bulbs and photovoltaic systems.

The invention relates to a method for producing foam glass by recycling a waste glass mixture containing display screen glass from television sets, computers or other monitors and glass from fluorescent tubes and/or energy-efficient lamps and/or photovoltaic systems, and foam glass obtainable from this process.

In March of 2005, the Waste Electrical and Electronic Equipment (WEEE) came into force. Basis of the Act forms the European Directive on Waste Electrical and Electronic Equipment (WEEE, 2002/96/EC of 27.01.2003) and the European Directive on the restriction of use of certain hazardous substances in electrical and electronic equipment (RoHS, Directive 2002/95/EC of Jan. 27, 2003).

Priorities of the Waste Electrical and Electronic Equipment Act is the prevention of waste in the area of electrical and electronic waste, reducing the amount of waste through reuse, guidelines for collection, recovery and recycling rates as well as reducing the pollutant content of the devices.

The key elements of the implemented regulations for electrical and electronic waste include:
The manufacturers must ensure application of best available technology for the treatment of discarded equipment.
Depending on the device category, between 70 percent and 80 percent of the equipment collected and shipped for treatment is to be recovered, between 50 percent and 75 percent of the material is to be recycled.

Furthermore, Annex III of the Waste Electrical and Electronic Equipment Act requires removal of the following materials and components by the recyclers:
Mercury-containing components and
Cathode ray tubes.

Here, the following components are to be treated as indicated:
Cathode ray tubes: removal of the luminescent layer;
Devices with ozone depleting gases or gases enhancing the greenhouse effect: expert removal and treatment of the gases; and
Gas discharge lamps: removal of the mercury.

A so-called “optimal implementation” of the Electrical and Electronic Equipment Act includes that all substances listed in Annex II of the WEEE Directive will be fully removed from electrical and electronic equipment and are present separately after sorting. The prescribed recovery rates are observed. Plastics are separated, if possible, and the materials are reused.

Major components of the above-mentioned electronic waste are inter alia technical glasses of different chemical composition and different optical and mechanical properties. The recovery of such glasses in the sense of “optimized implementation” of the Electrical and Electronic Equipment Act is an object of the present invention and thus the subject of further consideration.

In 2001, about 30,000 to 50,000 tons of used CRTs were available on the market. A CRT constitutes approximately 58 percent of the total composition of a cathode ray tube device.

The number of recovered gas discharge lamps is estimated to be 26.081000 pieces in total. A fluorescent tube weighs on the average 164 g (data supplied by various lamp manufacturers). Consequently, the weight of the recovered gas discharge lamps is about 3,750 tons. This amount has increased due to the mandated replacement of conventional incandescent lamps by so-called energy-saving or gas discharge lamps, and will therefore continue to increase in the future.

No numbers are available regarding the quantity of recycled glass from photovoltaic systems, but the volume is also expected to rise sharply in the coming years.

For a discussion of the process for the actual state of the recycling process of chemically polluted industrial glasses, an exemplary consideration of the disposal of monitor glass from cathode ray tubes and glass from gas discharge lamps to be recycled will be sufficient.

The current practical treatment in recycling or disposal of monitor glass from cathode ray tubes was that it was assumed in the recycling of CRT devices that a small fraction (about 10 percent) of the CRTs is mechanically separated into a lead-containing cone glass fraction and a lead-free screen glass fraction. The rest of the picture tube is then deposited, serves as backfill material for underground tunnels to prevent damage from mountain settling (screen glass) or is used in small amounts as an additive in the lead smelting (cone glass).

Furthermore, this residue is used as road construction material and in the ceramic industry. The plastic fraction is deposited in a landfill or incinerated.

Conversely, the optimized implementation of the Waste Electrical and Electronic Equipment Act in the above sense requires that all CRTs are recycled and processed into new glass. They are neither deposited in landfills nor used as backfill. The plastic fraction is incinerated.

A known method for the production of new glass in the sense of an optimized implementation is known from DE 10241 881 83, which describes a method for recycling screen glass discarded CRTs. This recycling typically occurs by treatment of the screen glass as a fraction of the glass melt in the display screen production. The need for a chemical and optical analysis of the screen glass which would be expensive and would significantly negatively affect the economy of previous methods for recycling screen glass is thereby eliminated. The glass composition of recycled screen glass is estimated, with the statistical age distribution of returned devices and the market shares of the glass manufacturer forming the basis for this estimate, followed by an iterative approach to the actual composition and the corresponding maximum added amount of recycled glass. Initially, a rather small amount of recycled glass, for example 2.5 percent, is added, so that the tolerances of the melt composition are not exceeded even when the estimated composition deviates significantly from the actual composition. The estimate of the composition is iteratively corrected based on an analysis of the melt and the percentage of added material is increased, until the maximum or the desired added amount is attained. The recycled glass can be in the form of ground screen glass or pieces of broken screen glass.

Since monitor glass is no longer required in large quantities due to the increasing replacement of CRTs with flat monitors, the above method has become obsolete. Adding monitor glass to container glass is limited due to the different temperature/viscosity curves of the glasses. The manufacture of other new, high-quality optical glass from recycled monitor glass is complicated by the sometimes only slightly different optical and mechanical properties of the individual monitor glass fractions due to different manufacturer formulations and data.

Recycling of glass from gas discharge lamps involved until now, for example, a re-use of the gas discharge lamps in accordance with a product-specific disassembly method, for example the so-called cap-separation method for fluorescent tubes, or in accordance with a non-product-specific method, i.e. a shredding process suitable for all types of lamps.

The advantage of the cap-separation process is that the recovered waste glass can be re-used again for the production of new gas discharge lamps. The recycled glass obtained from the shredding process, however, is utilized due to its poorer quality, for example due to a higher mercury content, mostly as backfilling material in the mining industry.

The intent of the present invention is not to produce new glass from the aforementioned glass resembling a glass melt, but rather to produce technically high-quality foam glass from the glass.

Foam glass is an inorganic, lightweight material with a mostly closed-cell structure, which has numerous technically useful and energetically favorable properties. These include high thermal insulation and zero-capillary action, a high compressive strength (surface load), resistance to acids and other chemicals, a large surface and light weight. In addition, the material is recyclable and has a positive ecological balance.

The production of foam glass can be distinguished essentially by two main methods:

According to a first method, the foam glass production is performed by extrusion of molten glass at temperatures above 1050° C. with the addition of a blowing agent, followed by cooling at simultaneous, sudden pressure drop, which leads to foam formation. This first method is unsuitable for the field of the invention because high-quality filter materials for medical purposes or polymer fill materials with highly reactive surfaces and similar applications are predominantly manufactured from these products, which do not allow metallic impurities which could enter the melt from the metal oxide constituents of, for example, screen glass. Furthermore, it is difficult for technical reasons to mix and extrude glasses with widely varying temperature and viscosity curves. Therefore, only small quantities of screen glass or glass fluorescent tubes can be added within the context of this method. Also, this first method is not suitable for large-scale applications for the composition production of foam glass and has a very poor energy balance due to the high processing temperature.

According to a second method, foam glass is produced from thermally sintered glass powder by adding a blowing agent mostly composed of several components, which upon thermal treatment in the temperature range between 810° C.-950° C. causes with a release of gas the formation of bubbles or foam and thus an expansion of the sintered glass composition. This method has a significantly better energy balance than the aforedescribed first method. The second method is further divided into subgroups “dry process” and the so-called “wet process”, with the sub-groups differing in the type of the blowing agent and the processing temperatures dependent thereon.

In the wet method, which is described for example in U.S. Pat. No. 5,516,351 A, a mostly alkaline binder in liquid form is added to the sintered composition prior to thermal treatment. This may be, for example, sodium silicate; other materials with heat-released OH-groups are also common. Depending on the product, continuous or batch furnaces are used for the thermal process. A corresponding wet process according to the second method, which is used for recycling CRT glass, is known from DE 9702 560 A1. In a first process step, constituents not containing glass are mechanically separated from the glass-containing constituents, the glass-containing components are in a subsequent process step mechanically pre-comminuted in a comminution device and then ground under addition of additives for the subsequent shaping and foaming to a particle size in the range from 1 μm-100 μm. Thereafter, the glass-containing constituents are formed in a granulator into a raw granulate by moistening with water, and converted by annealing in a sintering range of the glass at temperatures <1000° C. into a glass foam granulate with a grain size of 0.05 cm-2.0 cm. The produced glass foam granulate can be used as fill material, for example, for earth grading work and/or incorporated into products, such as in plaster, cement and plastics, as a filler in proportions of between 10 percent by volume and 80 percent by volume for improving the properties of these products.

DE 19545 187 A1 describes a mineral foam granulate, consisting of a core and an outer shell made each of different mineral foam structures, and a method and an apparatus for producing such a mineral foam granulate. The proportion of broken glass pieces from discharge lamps can reach 20 percent.

Wet process according to the second method described above are largely unsuitable for recycling process with the objective to produce high-quality technical foam glass, because, for example, screen glass (as well as glass from fluorescent lamps) contains, as mentioned above, many metal oxides. This is also evident, among other things, from the known typical composition of screen glass disclosed in DE 44 19388 A1. DE 44 19388 A1 describes a method for recycling of waste material in the form of the screen glass from CRTs from television sets and computer monitors. The typical composition disclosed therein includes, in wt %: 55.0 SiO₂; 10.2 Na₂O; 9.1 PbO; 6.3 BaO; 6.0 K₂O; 5.8 SrO: 2.5 Al₂O₃; 1.8 CaO; 1.2 ZrO₂; 0.4 MgO; 0.2 TiO₂, 0.1 Fe₂O₃; 2.4 other components. The metal oxides may react with other alkali and organic additives. For example, according to WOE 80/00696, a colloidal dispersion is used as blowing agent in the preparation of a foam glass granulate, which contains water, silicate (water glass) and a hydrocarbon compound, preferably glycerol, soluble in water glass, and preferably also an alkali bentonite, in particular sodium bentonite. In a wet method according to the aforedescribed second method, the alkaline and organic additives would cause the formation of salts or other chemical reaction with the metal oxides in the resulting foam glass, which could then lead to an undesirable release of the residual heavy metals due to chemical or galvanic corrosion in the final product.

Another disadvantage of the wet method is that the necessary drying process of the sintered composition and the required heat of evaporation for the phase change cause an unfavorable energy balance of the wet process. In addition, heavy metal particles would be entrained when the water vapor escapes, which requires considerable protection measures in the manufacturing process to protect the surrounding atmosphere.

Thus, only the above-mentioned “dry process” remains feasible for a recycling process for the production of high-quality foam glass with the second method. Here, due to the higher processing or foaming temperature compared to the wet process (also called activator), mostly inorganic carbon carriers, such as silicon carbide (SiC), are used as blowing agent. In addition, metal oxides may be incorporated as oxidizers to improve foaming.

Upon reaching a typical foaming temperature of 930° C.-970° C., the carbon of the activator is oxidized with oxygen from the ambient air to form carbon dioxide (CO₂) Also, the oxygen of the metal oxides combines with the carbon of the activator, which causes foaming of the glass powder composition which has at this temperature softened and sintered.

The glass powder mixture used in the second method in the so-called dry method typically consists of container glass waste, which is not melted down by the glass container industry due to mostly colored impurities, and—depending on the desired properties of foam glass to be produced—a fraction of (old) flat glass, for example window glass or auto glass. These types of glass can be substituted to a large extent by glass from fluorescent tubes, energy-efficient lamps and photovoltaic systems due to their similar compositions and (thereto-mechanical) properties; previously, fractions between 10 percent-70 percent were feasible, depending on the desired properties of the final product. Disadvantageously, however, a significant proportion of uncontaminated waste glass is still mixed with the (residual) contaminated glass, which is not in conformance with an “optimized implementation” of the Electrical and Electronic Equipment Act. A 100% substitution of the uncontaminated waste glass by glass from fluorescent tubes, energy-efficient lamps and photovoltaic systems is not possible in a conventional manner due to the then rapidly deteriorating mechanical properties of the foam glass end product, because for example glasses from fluorescent tubes and energy-efficient lamps are not only manufactured from soda-lime-type glasses, but also with a composition that is greatly different from container glass, as described in DE 697 01 439 12 (numbers are in weight percent):

55-70 SiO₂; 2-6 Al₂O₃; 0.5-4 Li₂O; <0.1 Na₂O; 10-15 K₂O; 0-3 MgO; 0-4 CaO; 4-7 SrO; 7-10 BaO; 0-0.5 CeO₂;

or contain according to DE 698 23 623 T2 the following representative fractions (numbers are in weight percent):

65-73 SiO₂; 1-5 Al₂O₃; 0.5-2 Li₂O; 5-10 Na₂O; 3-7 K₂O; 0.5-2 MgO; 1-3 CaO; 1-10 SrO; 1-15 BaO; 0-3 B₂O₃; 0-2 Sb₂O₃; 0-0.5 Fe₂O₃; >0 B₂O₃; >0 Sb₂O₃, and have hence also different thermal viscosity properties.

Screen glass in the aforedescribed typical composition could advantageously be added, since screen glass has excellent mechanical strength values when cold. However, this is possible only in the drying process at the usual processing temperatures of 920° C.-960° C. to a minor proportion of up to 5 percent of additional screen glass due to the different temperature-viscosity curve of the glasses, because the screen glass has a low viscosity at this temperature. It “softens” too much and results, when its percentage is greater than 5 percent, in a “running” large-pore foam material, with has inadequate mechanical properties after cooling.

The U.S. 2008/0236202 A1 describes the production of foam glass granulate in a tunnel furnace, wherein the glass material used as a raw material in the process can come from various sources, including lamp glass and screen glass. The tunnel oven includes two heating zones. In the first zone, the starting material is pre-heated to a temperature in the range 400° C.-900° C. In the second zone, the foaming region, the glass material is then heated to a temperature above 900° C. The disadvantage of this method is that the glass mixture for the production of foam glass granulate from the various sources still requires a relatively high proportion of at least 20 percent of little contaminated or uncontaminated container glass and temperatures above 900° C. for the foaming process.

It is the object of the present invention to provide a cost-effective and energy-saving method, in which the technical glasses, which even today are still disposed for the most part as backfill, is returned to the material cycle or can be refined into new high-quality products.

The object of the invention is attained with a process for the production of foam glass by recycling a waste glass mixture containing screen glass from television sets, computers or monitors (hereinafter referred to as “screen glass”) and glass from fluorescent tubes and/or energy-efficient lamps and/or photovoltaic systems. According to the invention, the method includes the following process steps performed in the listed order:
separately grinding individual fractions of the waste glass coming from various sources to produce glass powder,
mixing a glass sinter composition of proportions of different glass powder fractions and an inorganic carbon carrier as an activator without the addition of water or other liquids in a dry process, and
heat treatment of the sintered glass composition, wherein the sintered glass composition is first subjected to a sintering process and thereafter to a foaming process taking place at temperatures in a temperature range of 855° C.-890° C., and then cooling the resulting foam glass.

According to the invention, the sintered glass composition composed of thermally sintered glass powder and an activator contains 85 wt %-99 wt % derived from screen glass and glass from fluorescent tubes and/or energy-efficient lamps and/or photovoltaic systems. At least 10 wt % of the sintered glass composition is derived from screen glass.

According to the concept of the invention, the formulation is changed from previous dry processes for the production of foam glass, which is surprisingly accompanied by a substantial reduction of the process temperature. The high proportion of various metal oxides in the screen glass is hereby advantageous, because the released oxygen reacts with the carbon of the activator to form carbon dioxide (CO₂) in some of these oxides far below the typical process temperature of the dry process, which is at 920° C.-960° C., and thus allows a foaming process of the sintered glass powder composition.

Extensive tests have shown that a temperature range from 850° C. to and including 890° C. is suitable for the inventive foam glass formation through admixture of screen glass. In this temperature range, the viscosity of the screen glass remains largely constant. The lower viscosity of the screen glass in comparison to the other glass fractions in the sintered glass composition also has advantageously better heat transfer between the particles of the glass composition in the sintering process and hence results in very uniform, fine-pored foaming.

According to the invention, inorganic carbon carriers, such as silicon carbide (SiC), may be used a blowing agent or activator. For the thermal process, apparatuses are preferably used, which are designed to be substantially gas-tight or can be subjected to a negative pressure.

The sintered glass composition is preferably composed of the following proportions, in wt %: 15-45 screen glass; 10-83 glass from fluorescent tubes and/or energy-efficient lamps and/or photovoltaic systems; 0-8 container glass; 1-2 activator. The proportion of less contaminated glass can be significantly reduced compared to comparable conventional methods or can be completely substituted by screen glass and glass from fluorescent tubes and/or energy-efficient lamps and/or photovoltaic systems.

The foaming process is preferably performed at temperatures in a temperature range of 855° C.-880° C.

A representative chemical composition of the preferably used screen glass is given by the following proportions in weight percent (wt %):

55.0 SiO₂; 10.2 Na₂O; 9.1 PbO; 6.3 BaO; 6.0 K₂O; 5.8 SrO; 2.5 Al₂O₃; 1.8 CaO; 1.2 ZrO₂; 0.4 MgO; 0.2 TiO₂; 0.1 Fe₂O₃; 2.4 other components.

A representative chemical composition of the glass from fluorescent and/or energy-efficient lamps and/or photovoltaic systems used in accordance with an embodiment of the method has the following proportions in weight percent (wt %): 55-70 SiO₂; 2-6 Al₂O₃; 0.5 to 4 Li₂O; <0.1 Na₂O; 10-15 K₂O; 0-3 MgO; 0-4 CaO; 4-7 SrO; 7-10 BaO; 0-0.5 CeO₂

In another embodiment, the used glass from fluorescent tubes and/or energy-efficient lamps and/or photovoltaic systems includes the following representative proportions in weight percent (wt %): 65-73 SiO₂; 1-5 Al₂O₃; 0.5-2 Li₂O; 5-10 Na₂O; 3-7 K₂O; 0.5-2 MgO; 1-3 CaO; 1-10 SrO; 1-15 BaO; 0-3 B₂O₃; 0-2 Sb₂O₃; 0-0.5 Fe₂O₃; >0 B₂O₃; >0 Sb₂O₃.

The desired foam glass properties can be exactly set depending on the composition, wherein the high-quality characteristics of the screen glass in relation to mechanical strength and homogeneity are particularly advantageous.

Surprisingly, the fractions of purified or uncontaminated glass can be completely replaced with screen glass and glass from fluorescent tubes and/or energy-efficient lamps or photovoltaic systems, as indicated by the lower limit of the proportion of container glass of 0 percent in the sintered glass composition. In accordance with an “optimized implementation” of the Electrical and Electronic Equipment Act, glasses from the purified fraction of the screen glass from CRTs and glasses from fluorescent tubes, wherein the luminescent layer has been removed, or glasses from gas discharge lamps and energy-efficient lamps can preferably be used.

Foam glass granulate and molded bodies or panels of foam glass are particularly suitable as end products. In the production of foam glass plates, the sintered glass composition is introduced into heat-resistant molding containers before the thermal treatment and compacted with suitable tools. In the preparation of foam glass granulate, the sintered glass composition is also compacted, but does not require containers. Foam glass granulate (foam glass gravel) is a lightweight mineral material generally used for insulation and stabilization. It allows heat-bridge-free construction. Its characteristics are high pressure stability, protection against pests and resistance to decay. The material is CFC-free, non-flammable and easy to work with, since it is introduced as loose fill in the building pit.

Ground foam glass granulate can also be used as an additive for heat-insulating and sound-proofing coatings or concrete as well as for fire-resistant or flame-retardant coatings or concrete.

Molded bodies or panels of foam glass offer a variety of applications, for examples in the construction industry for cladding, for sound-proofing, for heat insulation of pipes, as static stabilizers, as flame and fire protection measures, as filter building blocks or in biotechnical applications.

Other objects, features and advantages of the invention will become apparent from the following description of exemplary embodiments.

Table 1 shows exemplary formulations and applied (process) material temperatures that have proven to be advantageous for foaming:

TABLE 1

| | | Glass from | | | |
|---|---|---|---|---|---|
| | | fluorescent | | | |
| | | tubes and | | | |
| | | Energy- | | | |
| | | efficient | | | |
| | | lamps or | Container | Activator | Process |
| | Screen glass | solar cells | glass in | in | temperature |
| No. | in percent | in percent | percent | percent | in ° C. |
| 1 | 40.0 | 50.0 | 8.0 | 2.0 | 855 |
| 2 | 15.0 | 83.0 | 0.0 | 2.0 | 870 |
| 3 | 30.0 | 68.5 | 0.0 | 1.5 | 880 |
| 4 | 45.0 | 53.0 | 0.0 | 2.0 | 855 |

in the following, an example of the production according to the invention of molded bodies from foam glass will be described with reference to the individual process steps I to IV.

At a first step the CRTs are pre-crushed. The screen glass, which is delivered separately as cone glass or picture tube glass, as well as glass from fluorescent tubes and energy-efficient lamps will mechanically comminuted with a suitable apparatus, such as a hammer mill or a press, a fraction size of maximally 30 mm-50 mm. CRT glass or cone glass and the glass from fluorescent tubes and energy-efficient lamps are here preferably also treated separately, since they differ greatly in their respective chemical composition; however, the individual glass fractions from different manufacturers can be safely mixed. Following homogeneous separation, the broken glass is then stored in suitable silos.

At a second step II, the pre-crushed screen glass fraction is then ground. The crushed glass fractions are then transported by suitable encapsulated delivery systems from the silos to a suitable mill, preferably a ball mill, where they are ground to a fraction size of 50 μm-80 μm. Subsequently, by using appropriate measures, such as screening and/or sifting, any remaining impurities are removed from the glass powder, which is then again stored in suitable storage silos, separated and sorted as screen glass or glass from fluorescent tubes and energy-efficient lamps.

At step III, the sintered composition is mixed. The individual components of the sintered composition are moved, preferably into an intensive mixer, by using suitable metering devices and—in contrast to the process described DE 19 702 560 A1—mixed without the addition of water or other liquids.

Preferably, the mixture may be present in the composition distributions described in the formulations of Table 1, wherein the formulation No. 3 will here be used as an example. The individual composition components therefore occur as follows:
glass from CRTs: 30.0 percent,
glass from fluorescent tubes and energy-efficient lamps: 68.5 percent, and
activator, here silicon carbide (SiC): 1.5 percent.

The silicon carbide (SiC) must in this case be present in the sintered composition with a fraction size of maximally 5 μm-10 μm due to the required homogeneous distribution. Thereafter, the sintered composition is moved into heat-resistant molding containers and compacted by using suitable tools, such as a roller, at a mechanical pressure of 5 N/cm² up to 20 N/cm². The molding containers with the sintered composition can then be moved to a suitable furnace.

At a subsequent process step IV, the thermal treatment and the foaming process are preformed. A suitable furnace is either a continuous furnace with an attached cooling line or preferably a furnace as described in the utility model DE 202009015849.7 U1. This furnace includes a heat transfer region with individual, horizontally superpositioned heat transfer units, wherein in each case a respective sub-chamber is formed between two heat transfer units and each of the horizontally superpositioned sub-chambers can be controlled in a separate heat transfer zone. The furnace is preferably constructed to be gas-tight or can be subjected to negative pressure.

The sintered composition according to the formulation No 3 in Table 1 is then heat-treated in the furnace according to the following temperature-time profile;

| | |
|---|---|
| IV1 | heating to 840° C. in 60 min, |
| IV2 | holding at 840° C. for 20 min, with the sintering process taking |
| | place, |
| IV3 | heating to 880° C. in 20 min, with the sintering process |
| | transitioning into a foaming process, |
| IV4 | holding the temperature at 880° C. for 30 min, with the foaming |
| | process taking place, |
| IV5 | cooling to 430° C. in 8 hours, thereby realizing a low-stress |
| | cooling process, and |
| IV6 | cooling to 50° C. in 3 hours, thereby likewise ensuring a low-stress |
| | cooling process. |

Foam glass bodies produced in accordance with the aforementioned characteristic have very good mechanical and thermal insulating properties.

The steps I-IV are also applied in the production of foamed glass granulate or foam glass gravel, with the difference that molding containers are not needed in this case. A continuous furnace is more useful for continuous production, but without a connected cooling section. The sintered composition is placed on the conveyor belt of the furnace at the furnace inlet in form of a continuous bed as an about 2 cm-4 cm high layer via a metering device, such as a metering screw, and mechanically compacted with a roller, as described at step III.

The temperature-time profile of the thermal treatment described at step IV is adjusted by way of the length and/or transport speed of the conveyor belt the low-stress cooling of the program steps IV5 and IV6 of the heat treatment is omitted. Instead, a cold air flow is applied to the resulting continuous foam glass layer at the outlet of the furnace, causing the layer to fracture due to the generated internal stresses into granule fractions or foam glass gravel of about 30 mm-60 mm, which is then stored or packaged for transport, or further fractionated and ground for other combination products.

Neither in the production of foam glass plates nor in the production of foam glass gravel is a granulate formed prior to thermal processing; instead, the glass powder mixture with the activator contained therein is metered onto the conveyor belt of the continuous furnace or enclosed in molding boxes for molded parts either as continuous bed or continuous layer (in the production of foam glass gravel) or as intermittent bed (in the production of foam glass plates). Preforming into a granulate would result in a lower production volume with the same size of the furnace and thus inevitably to increased energy consumption or production volume, because the main heat capacity is taken up by the conveyor belt of the oven. These disadvantages are eliminated with the method according to the invention. The method is therefore suitable for both mass production and waste disposal.

1. Method for producing of foam glass by recycling a waste glass mixture containing screen glass for television sets, computers or other monitors and glass from fluorescent tubes and/or energy-efficient lamps and/or photovoltaic systems, the method comprising the following method steps in the indicated order:
separate grinding of individual fractions of the waste glass coming from various sources to produce glass powder,
mixing a glass sinter composition of proportions of different glass powder fractions and an inorganic carbon carrier as an activator without the addition of water or other liquids in a dry process, and
heat treatment of the sintered glass composition, wherein the sintered glass composition is first subjected to a sintering process and thereafter to a foaming process taking place at temperatures in a temperature range of 855° C.-890° C., and then cooling the resulting foam glass,
characterized in that
the sintered glass composition composed of thermally sintered glass powder and an activator having a weight fraction of 85 percent-99 percent derived from screen glass and glass from fluorescent tubes and/or energy-efficient lamps and/or photovoltaic systems contains at least 10 wt % of screen glass.

2. The method according to claim 1,
characterized in that
silicon carbide (SiC) is used as activator.

3. The method according to claim 1 or 2,
characterized in that
apparatuses, which are substantially gas-tight or which can be subjected to negative pressure, are used for the thermal processing.

4. A method according to one of the claims 1 to 3,
characterized in that
the sintered glass composition is composed of 15 wt %-45 wt % of screen glass, 10 wt %-83 wt % of glass from fluorescent tubes and/or energy-efficient lamps and/or photovoltaic systems, 0 wt %-8 wt % of glass containers, and 1 wt % to 2 wt % of the activator.

5. The method according to one of the claims 1 to 4,
characterized in that
the foaming process is carried out at ter peratures in a temperature range from 855° C. to 880° C.

6. The method according to one of the claims 1 to 5,
characterized in that
the representative chemical composition of the employed screen g given in the following proportions by weight: 55.0 SiO₂; 10.2 Na₂O; 9.1 PbO; 6.3 BaO; 6.0 K₂O; 5.8 SrO; 2.5 Al₂O₃; 1.8 CaO; 1.2 ZrO₂; 0.4 MgO; 0.2 TiO₂; 0.1 Fe₂O₃; 1.4 other components.

7. The method according to one of the claims 1 to 5,
characterized in that
the representative chemical composition of the employed glass from fluorescent tubes and/or energy-efficient lamps and/or photovoltaic systems is given in the following proportions by weight: 55-70 SiO₂; 2-6 Al₂O₃; 0.5 to 4 Li₂O; <0.1 Na₂O; 10-15 K₂O; 0-3 MgO; 0-4 CaO; 4-7 SrO; 7-10 BaO; 0-0.5 CeO₂ or contains the following, representative proportions in wt %: 65-73 SiO₂; 1-5 Al₂O₃; 0.5-2 Li₂O; 5-10 Na₂O; 3-7 K₂O; 0.5-2 MgO; 1-3 CaO; 1-10 SrO; 1-15 BaO; 0-3 B₂O₃; 0-2 Sb₂O₃; 0-0.5 Fe₂O₃; >0 B₂O₃; >0 Sb₂O₃.

8. Foam glass, obtained by a method according to one of the claims 1 to 7.

9. Combination materials which are at least partly made of foam glass according to claim 8.

10. Use of foam glass or combination materials according to claim 8 or 9 for sound proofing, heat insulation, cold insulation and/or fire walls.
